(19) United States
(12) Patent Application Publication
(10) Pub. No.: US 2015/0123349 A1
(43) Pub. Date: May 7, 2015

(54) HYGIENIC SEAL SYSTEM

(71) Applicant: AES ENGINEERING LTD, Mill Close, Rotherham (GB)

(72) Inventor: Steven Cox, Borrowash (GB)

(73) Assignee: AES ENGINEERING LTD., Rotherham (GB)

(21) Appl. No.: 14/408,186

(22) PCT Filed: Jun. 13, 2013
(86) PCT No.: PCT/GB2013/000263

§ 371 Date: Dec. 15, 2014

(30) Foreign Application Priority Data
Jun. 14, 2012 (GB) 1210611.8

(51) Int. Cl. F16J 15/34

(52) U.S. Cl. CPC F16J 15/3464; F16J 15/3436
USPC 277/390

(57) ABSTRACT

A modular mechanical seal assembly for use in hygienic and aseptic application having few, if any, cavities in which bacteria and pathogens could grow, includes a longitudinally floating first seal face member, a longitudinally static second seal face member, a biasing device for urging the first seal face member to contact with the second seal face member, a longitudinally static shaft location member, a first sealing member and a second sealing member. The second sealing member is formed as an elastomeric member positioned between the static seal face and the equipment housing and the first sealing member is formed as an elastomeric member and positioned between an item of rotating equipment and the shaft location member, in which the elastomeric members substantially seal off at least one cavity of the seal assembly.

### FIELD OF THE INVENTION

This invention relates to mechanical seals which are fitted to rotating equipment in virtually all types of industries.

### BACKGROUND TO THE INVENTION

A mechanical seal comprises a “floating” component which is mounted axially movably around the rotary shaft of, for example, a pump and a “static” component which is axially fixed, typically being secured to a housing. The floating component has a flat annular end face, i.e. its seal face, directed towards a complementary seal face of the static component. The floating component is urged towards the static component to close the seal faces together to form a sliding face seal, usually by means of one or more spring members. In use, one of the floating and static components rotates; this component is therefore referred to as the rotary component. The other of the floating and static components does not rotate and is referred to as the stationary component.

Those seals whose floating component is rotary are described as rotary seals. If the floating component is stationary, the seal is referred to as a stationary seal.

If the sliding seal between the rotary and stationary components are assembled and pre-set prior to despatch from the mechanical seal manufacturing premises, the industry terminology for this is “cartridge seal”. If the rotary and stationary components are despatched individually (unassembled) from the mechanical seal manufacturing premises, the industry terminology for this is “component seal”.

Mechanical seals are used in all types of industries to seal a variety of different process media and operating conditions. The general industry term which defines the area adjacent to the process media is “inboard”. The industry term which defines the area adjacent to the atmospheric side is “outboard”.

There are many ways in which mechanical seals can be secured to the shaft of an item of rotating equipment. The use of radially acting set-screws is one common mechanical method. Boot mounting, using an elastomeric member is one common frictional method.

In hygienic and aseptic applications, as found in the food, drink and pharmaceutical industry, the profile of components in contact with the process media is extremely important so to minimise or eliminate places where pathogens and bacteria can grow.

For cartridge seals, hygienically profiling the wetted components of the mechanical seal is generally accomplished by positioning the clamping device out of the processed media at the atmospheric side of the sealing means. Unfortunately, this is not always possible in component seal design, therefore the seal clamping area becomes an ideal place for bacteria growth.

It is deemed advantageous if a component mechanical seal design could be offered which provided a hygienic profile for parts in contact with the process media.

### STATEMENTS OF THE INVENTION

According to the present invention there is provided a mechanical seal assembly intended to seal a piece of industrial equipment. The said seal is comprises:
a longitudinally floating first seal face member
a longitudinally static second seal face member
a biasing means urging first seal face member to contact with second seal face member
a longitudinally static shaft location member
a first sealing member
a second sealing member
   wherein, the second sealing member is in the form of an elastomeric member positioned between the static seal face and the equipment housing and the sealing member is in the form of an elastomeric member positioned between the item of rotating equipment and the shaft location member and characterised in that it substantially seals off cavities where bacteria and pathogens could grow.

Providing the first and second sealing members to substantially, and in some circumstances totally, seal of all cavities where bacteria and pathogens could grow, makes the seal appropriate for use in situations where hygiene is critical, for example in the food and drink industry and/or the pharmaceutical industry.

Preferably, the longitudinally floating member is radially disposed to the longitudinally static shaft location member, and preferably the radial interface and cavities between the two members is totally sealed by a second sealing member, restricting bacteria and pathogen growth potential.

Preferably, the first and/or the second shaft sealing members are designed to be installed in a conventional o-ring groove. As a result, the metallic members are modular to both the first and/or second sealing members and conventional round o-rings, thereby allowing relatively simple installation.

Preferably the wetted parts of the component seal design of the invention are hygienically profiled.

Preferably, the component mechanical seal of the invention is designed to be installed in confined radial space applications, specifically DIN 24 960.

The reader will relate to various benefits of the mechanical seal of the invention which will now herewith be described with the aid of the following drawings.

### DESCRIPTION OF THE DRAWINGS

The accompanying drawings are as follows:

FIG. 1 is a partial longitudinal view of a component mechanical seal in accordance with the present invention.

FIG. 2 corresponds to FIG. 1 and is a partial longitudinal view of a component mechanical seal with elastomeric O-rings.

### DETAILED DESCRIPTION OF THE INVENTION

The invention will now be described, by way of examples only, with reference to the accompanying drawings.

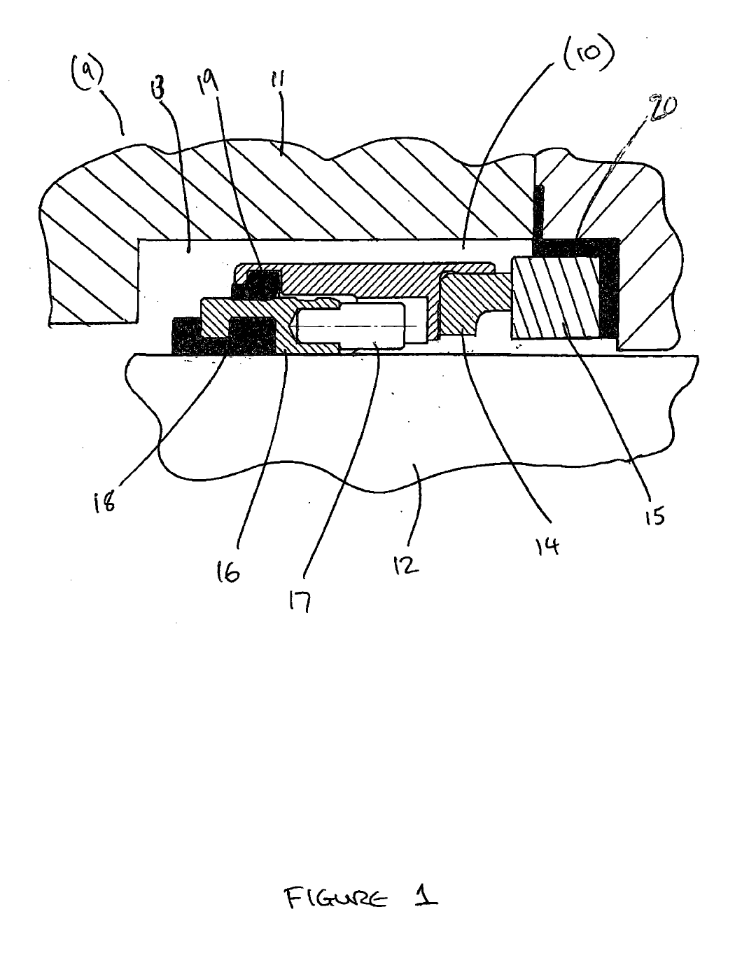

FIG. 1 is a longitudinal view of a component mechanical seal 10 of the invention

The mechanical seal 10 is installed on an item of rotating equipment such as a pump 9 comprising many components and including a static housing 11 and a rotatable shaft 12. The pump 9 processes a fluid 13, hereafter called “process fluid”.

The mechanical seal 10 comprises a longitudinally floating seal face 14 and a longitudinally static seal face 15, preferably biased towards each other by biasing means, for example one or more spring like members (not shown).

The biasing means, especially where spring like members are used, is preferably positioned out of the process media 13.

Said seal face 14 is mounted on a shaft location member 16 so that when the component seal 10 is installed on a parallel shaft 12, hydraulic seal face balance can be accomplished. The experienced reader will relate to the benefits of hydraulic seal face balance.

A drive mechanism 17 transmits the rotational drive from the shaft location member 16 to the longitudinally floating seal face member 14. The drive member 17 is also positioned out of the process media 13.

A first elastomeric member 18 provides a seal between the rotating shaft 12 and the shaft location member 16. A second elastomer member 19 provides a seal between the shaft location member 16 and the seal face 14. A third elastomer member 20 provides a seal between the axially static seal face 15 and the housing 11.

The mechanical seal 10 comprising the seal faces 14 and 15 and the elastomeric members 18, 19 and 20, prevent the process media 13 from escaping the pump 9.

Preferably, the first elastomeric member 18 is designed to have a frictional interference and hence transmit rotational movement from the shaft 12 to the shaft location member 16.

Preferably, the first elastomeric member 18 seals all the process media exposed cavities between the shaft location member 16 and the shaft 12.

Preferably the second elastomeric member 19 seals all the process media exposed cavities between the shaft location member 16 and the seal face 14.

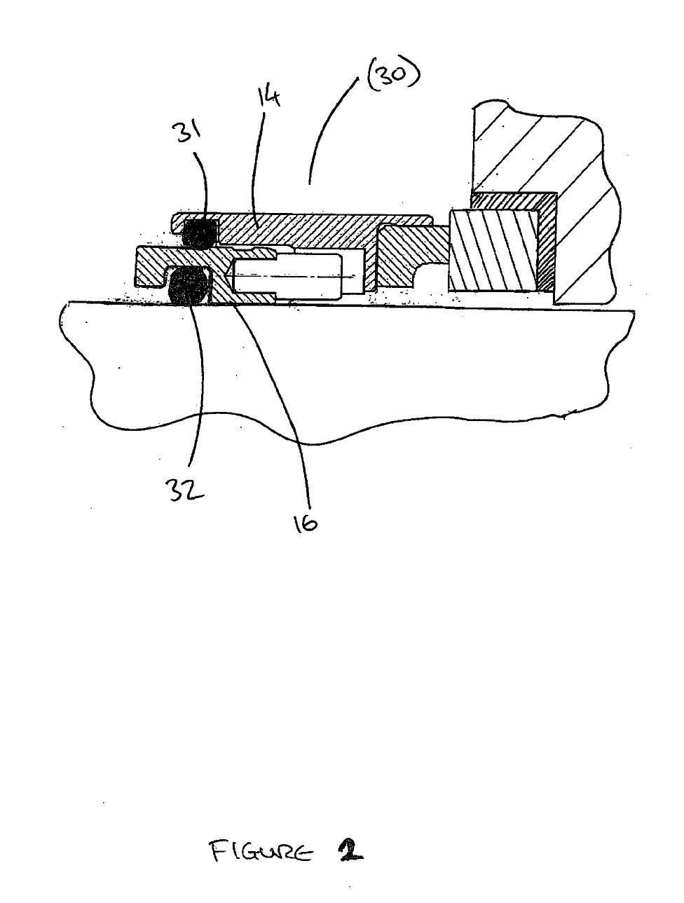

FIG. 2 corresponds to FIG. 1 and is a partial longitudinal view of a component mechanical seal 30 with elastomeric O-rings 31 and 32.

The reader will note that the elastomeric O-rings 31 and 32 can be installed in the cavities which were previously occupied by elastomeric members 18 and 19 of FIG. 1, without a change to the shaft location member 16 and rotary seal face 14 being required.

This modularity allows the mechanical seal to be offered in any combination of sealing device, whether it is one which is hygienically profiled as shown in FIG. 1 or one of standard o-ring cross section as shown in FIG. 2.

From FIG. 1, preferably, the seal can be installed in rotating equipment which conform to DIN 24 960, comprising of radial cross sectional spaces as small as 8 mm (0.236″).

1-9. (canceled)

10. A mechanical seal assembly for sealing an item of rotating equipment, comprising:
a longitudinally floating first seal face member;
a longitudinally static second seal face member;
biasing means for urging said longitudinally floating first seal face member to contact said longitudinally static second seal face member;
a longitudinally static shaft location member;
a first sealing member formed as an elastomeric member positioned an item of rotating equipment and said longitudinally static shaft location member; and,
a second sealing member formed as an elastomeric member positioned between said longitudinally static second seal face member and a housing for the item of rotating equipment, wherein said first sealing member and said second sealing member substantially seal off at least one cavity of said mechanical seal assembly.

11. The mechanical seal assembly for sealing an item of rotating equipment according to claim 10, wherein said longitudinally floating first seal face member is radially disposed to said longitudinally static shaft location member and a radial interface and at least one cavity between said first sealing member and said second member is substantially sealed by said second sealing member.

12. The mechanical seal assembly for sealing an item of rotating equipment according to claim 10, wherein at least one of said first sealing member and said second sealing member are installed in an O-ring groove.

13. The mechanical seal assembly for sealing an item of rotating equipment according to claim 10, wherein said first sealing member has a frictional interference for transmitting rotational movement from a shaft of the item of rotating equipment to said longitudinally static shaft location member.

14. The mechanical seal assembly for sealing an item of rotating equipment according to claim 10, wherein said first sealing member seals all process media exposed cavities between said longitudinally static shaft location member and a shaft of the item of rotating equipment.

15. The mechanical seal assembly for sealing an item of rotating equipment according to claim 10, wherein said second sealing member seals all process media exposed cavities between said longitudinally static shaft location member and a longitudinally floating first seal face member.
